(19) United States
(12) Patent Application Publication
(10) Pub. No.: US 2026/0168434 A1
(43) Pub. Date: Jun. 18, 2026

(54) DUAL WASTEGATE VALVE ARRANGEMENT

(71) Applicant: BorgWarner Inc., Auburn Hills, MI (US)

(72) Inventors: Mateusz KROCHMAL, Czudec (PL); Wojciech TASIOR, Rzeszów (PL)

(21) Appl. No.: 19/397,998

(22) Filed: Nov. 23, 2025

(30) Foreign Application Priority Data
Dec. 13, 2024 (DE) 20 2024 107 253.7

(51) Int. Cl. F02B 37/18

(52) U.S. Cl. CPC F02B 37/183

(57) ABSTRACT

A double wastegate valve arrangement having improved durability and reduced overall loading in the system, with two wastegate valves movable along a valve longitudinal axis, wherein each of the two wastegate valves has a rotationally symmetrically designed projecting upper side portion configured around the valve longitudinal axis, a valve arm connected to an actuating shaft, and an intermediate plate which is loosely arranged between the valve arm and the wastegate valves, wherein the intermediate plate is pivotable about the valve arm in a direction perpendicularly with respect to the valve longitudinal axis and is supported by rotationally symmetrically designed projecting lower side portions of the intermediate plate on the rotationally symmetrically designed projecting upper side portions of the two wastegate valves.

The invention relates to a double wastegate valve arrangement.

The use of turbochargers serves to increase the efficiency of internal combustion engines. Such an exhaust-gas turbocharger is responsible for pumping compressed air into the internal combustion engine. A compressor of the exhaust-gas turbocharger is driven by an exhaust-gas-driven turbine. The rotation of a turbine wheel caused by the exhaust gases of the internal combustion engine is transmitted via a shaft to a compressor wheel, as a result of which the air is compressed and pumped. The internal combustion engine in conjunction with the exhaust-gas turbocharger can be used in vehicles, for example in a passenger car or a lorry. Turbochargers can be used in conjunction with diesel or petrol engines, but also with engines which are powered by methane or compressed natural gas.

In some applications, especially in light commercial vehicles, a dual volute turbine stage can be advantageous. In the dual volute turbine stage, the exhaust-gas flow is conducted through two separate spiral housings, each of which directs the exhaust gas pulses directly into one half of the turbine wheel. Each spiral has its own wastegate opening.

In addition, dual volutes are known, in which the manifold and the turbine housing are divided into two flow paths, with the result that the ignition sequence of the engine can change the flow and transmit the pulse energy directly to the turbine wheel.

What these applications have in common is that two wastegate ports have to be accommodated. In principle, a wastegate with two ports can be operated with a single valve plate. However, a large wastegate port and a large valve plate are required to achieve a high bypass ratio. In addition, the valve arm has to be long in order to accommodate the large valve, with the result that the load in the system is high.

U.S. Pat. No. 5,996,348 A discloses an improved wastegate valve for turbochargers with forked exhaust-gas inlets, which comprises a first bypass opening, which is connected to a first part of the exhaust-gas inlet, a first valve plate, which engages and seals a seat surrounding the first opening, a second bypass opening, which is connected to a second part of an exhaust-gas inlet and comprises a second valve plate which engages and seals a seat surrounding the second opening. The valves are actuated by a first, substantially tubular shaft which is rotatably mounted around an axis and has a central bore, and a second, substantially tubular shaft which extends through the central bore of the first shaft and is mounted therein rotatably about the axis. The two shafts are rotated simultaneously by a lever arm which is connected to the first shaft at an end lying opposite the radial arm by way of a welded bead extending over the end face of the first shaft, the bore and a coplanar end of the second shaft.

U.S. Pat. No. 8,336,309 B2 discloses a turbocharger wastegate valve assembly comprising a first bypass opening which is connected to a first portion of an exhaust-gas inlet and a first valve element which is suitable for engaging into and sealing a first valve seat surrounding the first bypass opening. The valve assembly further comprises a second bypass opening which is connected to a second part of an exhaust-gas inlet, and a second valve element which is suitable for engaging with and sealing a second valve seat surrounding the second opening. A shaft supports each valve element for rotation about a shaft axis in order to lift both the first and second valve element out of the seal engagement with the first and second valve seat, respectively. The first valve seat is inclined relative to the second valve seat, and the shaft is freely movable in the axial direction.

U.S. Pat. No. 11,441,478 B2 discloses a turbine comprising a turbine housing which defines a turbine inlet upstream of a turbine wheel and a turbine outlet downstream of the turbine wheel; and a wastegate valve arrangement comprising at least one movable valve element mounted on a movable carrier element within a wastegate chamber which is connected to the turbine inlet upstream of the turbine and has one or more chamber outlets which are connected to an outlet of the turbine. The valve element can rotate slightly about the carrier element, wherein the extent of the rotation in the respective directions is limited by collisions between a respective boundary point on a boundary region on a rear surface of a sealing portion of the valve element and a respective boundary point on a boundary region on a front surface of the carrier element.

U.S. Pat. No. 11,149,579 B 2 discloses a turbine comprising a turbine housing which defines a turbine inlet upstream of a turbine wheel and a turbine outlet downstream of the turbine wheel; and a wastegate valve arrangement comprising at least one movable valve element mounted on a movable carrier element within a wastegate chamber which is connected to the turbine inlet upstream of the turbine and has one or more chamber outlets which are connected to an outlet of the turbine. The valve element can rotate slightly about the carrier element, wherein the extent of the rotation is limited by collisions between corresponding boundary regions on a rear surface of a sealing portion of the valve element and a front surface of the carrier element. Each valve element is connected to the support element via a pin portion of the valve element, which passes through a washer with a non-circular outer profile, and the rotation of the washer is limited by contact surfaces of the support element.

In view of the prior art cited above, it is an object of the invention to provide a double wastegate valve arrangement which has improved durability and reduced overall loading in the system.

This object is achieved by independent Patent claim 1. Further advantageous embodiments of the invention are in each case the subject matter of the dependent claims. These embodiments can be combined with one another in any technologically expedient manner. The description, in particular in conjunction with the drawing, additionally characterizes and specifies the invention.

According to the invention, a double wastegate valve arrangement is provided. The double wastegate valve arrangement comprises two wastegate valves movable along a valve longitudinal axis, wherein each of the two wastegate valves has a rotationally symmetrically designed projecting upper side portion configured around the valve longitudinal axis, a valve arm connected to an actuating shaft, and an intermediate plate which is loosely arranged between the valve arm and the wastegate valves, wherein the intermediate plate is pivotable about the valve arm in a direction perpendicularly with respect to the valve longitudinal axis and is supported by rotationally symmetrically designed projecting lower side portions of the intermediate plate on the rotationally symmetrically designed projecting upper side portions of the two wastegate valves.

The double wastegate valve arrangement according to the invention can be used for dual volute housings and dual volute turbine housings. It has two wastegate ports and two separate wastegate valves mounted on a valve arm. It is possible to compensate for the thermal expansion of the turbine housing and the dimensional deviations of the system in order to ensure the tightness of the wastegate valve. Each wastegate valve can move independently of the other. Separate ports reduce the influence of exhaust gas pulses, which results in improved durability. Compared to a single valve plate with the same wastegate port area, the overall loading in the system is lower due to the shorter arm. A main feature of this invention is the ability to compensate for deviations between the two valves (ports) and to ensure a perfect seal of both connections. This is achieved by providing an intermediate plate between the valve arm and the two wastegate valves, which intermediate plate is not rigidly connected to the valve arm but rather can rotate. Accordingly, an additional force is applied to the wastegate valve, which is not yet in contact with its valve seat on the turbine housing, since the intermediate plate rotates in the direction of this valve, while the other wastegate valve is already in contact with its valve seat.

According to one embodiment of the invention, the rotationally symmetrically designed projecting lower side portions of the intermediate plate and the rotationally symmetrically designed projecting upper side portions of the wastegate valves are designed conically or as chamfers.

Wastegate valves as a rule have a valve stem which is formed along the valve longitudinal axis. The valve stem is surrounded by the projecting upper side parts. In order to ensure the rotational symmetry, the upper side parts can be designed to be conical or as chamfers, for example. The corresponding lower side parts of the intermediate plate can have the same shape.

According to a further embodiment of the invention, the rotationally symmetrically designed projecting lower side portions of the intermediate plate and the rotationally symmetrically designed projecting upper side portions of the wastegate valves are of spherical design. In this embodiment, a radius of the concave spherical lower side portion on the intermediate plate can be greater than or equal to a radius of the convex spherical upper side portion at the two wastegate valves.

In order to facilitate the movement of the wastegate valve relative to the intermediate plate, a spherical shape of the lower and upper portions is preferred. By using slightly different radii, manufacturing tolerances can be compensated for.

According to another embodiment of the invention, the actuating shaft is connected to the valve arm in a symmetrical position in the middle between the two wastegate valves.

In symmetrical applications with respect to the wastegate ports on the two spiral channels, the two wastegate valves can be connected at a symmetrical position, with the result that the system loading on the valve arm is of equal magnitude for the two wastegate valves.

According to a further embodiment of the invention, the actuating shaft is connected to the valve arm in a position which lies closer to one of the two wastegate valves.

This approach is particularly advantageous when the load on the different wastegate valves is different.

According to a further embodiment of the invention, projecting elements which act in conjunction with the intermediate plate as an anti-rotation safeguard are formed on the two wastegate valves.

In order to prevent the wastegate valves from rotating about their longitudinal axis, anti-rotation safeguards are provided which limit the movement of the wastegate valves relative to the intermediate plate.

According to a further embodiment of the invention, the intermediate plate pivots about the valve arm by corresponding curved regions being formed on the intermediate plate and the valve arm. In this embodiment, a positively curved region can be formed on the intermediate plate, and a negatively curved region can be formed on the valve arm. In addition, the curved regions can be of cylindrical shape, and a radius of the cylindrical region on the intermediate plate can be less than or equal to a radius of the cylindrical region of the valve arm.

The contact surface between the valve arm and the intermediate plate is formed by corresponding curved regions which are preferably cylindrical. Accordingly, a cylindrical recess is formed in the middle of the valve arm. In the middle of the intermediate plate is a cylindrical convex surface which is in contact with the concave cylindrical surface of the valve arm. The diameter of the concave cylinder of the valve arm is equal to or greater than that of the convex cylinder of the intermediate plate. By using different radii, manufacturing tolerances can be compensated for and a smooth movement of the parts is possible. Due to this type of contact, the intermediate plate can tip in relation to the slide arm. The sealing surfaces of the wastegate valves cover the deviations of each wastegate seat separately. As a result, the two wastegate valves are tight in the closed state.

According to a further embodiment of the invention, the valve arm has a pin which engages into the intermediate plate and creates a pivotable connection. In this embodiment, the pivotable connection can be limited by a stop element.

Compared to the previous embodiment, the intermediate plate is connected to the valve arm by a pin/hole interface. The pin is part of the valve arm, and the hole is part of the intermediate plate. The diameter of the pin is equal to or smaller than that of the hole, making it a loose fit. The intermediate plate can rotate about the axis of the valve arm pin. This allows the wastegate assembly to cover and compensate for geometrical deviations of the assembly and the wastegate seats, ensuring the tightness of the two wastegate valves.

Advantageously, the above-described double wastegate valve arrangement with a twin volute or a dual volute housing can be used.

In addition, a turbocharger can contain the double wastegate valve arrangement described above. The turbocharger can be used in an internal combustion engine powered by diesel, hydrogen, methane or compressed natural gas (CNG).

The concept according to the invention can be used in all applications with a high wastegate-bypass ratio and high durability requirements. The invention leads to reduced exhaust-gas leakage through the wastegate valve in turbine housings with two wastegate valves. The invention reduces the total loading of the wastegate system compared to a single-valve solution with the same wastegate port area.

In the figures, identical or identically acting components are provided with the same reference signs.

In the figures:

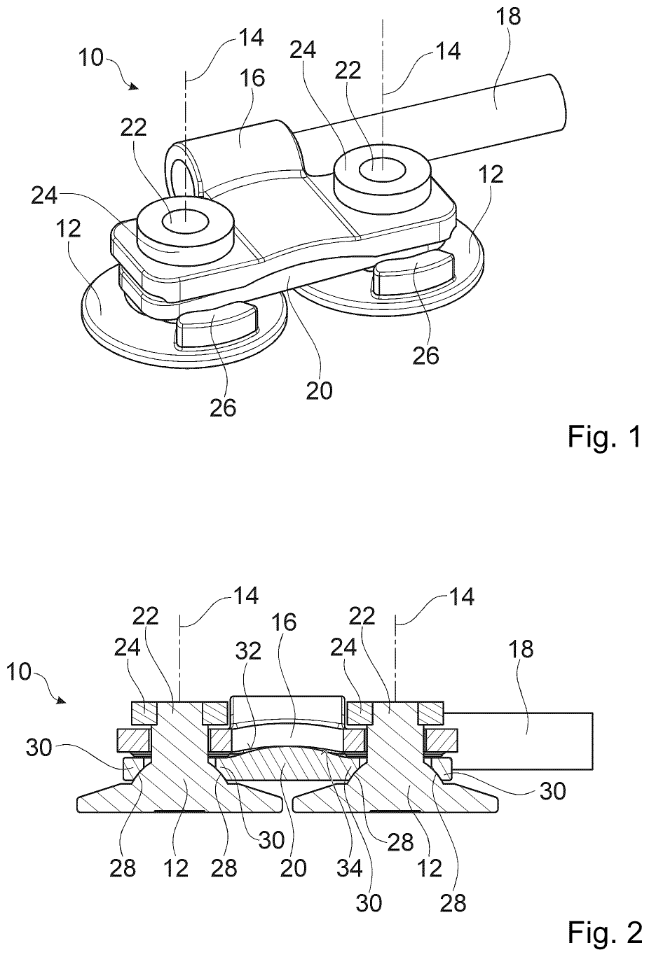

FIG. 1 shows a first embodiment of a double wastegate valve arrangement in a perspective side view,

FIG. 2 shows the double wastegate valve arrangement from FIG. 1 in a cross-sectional view,

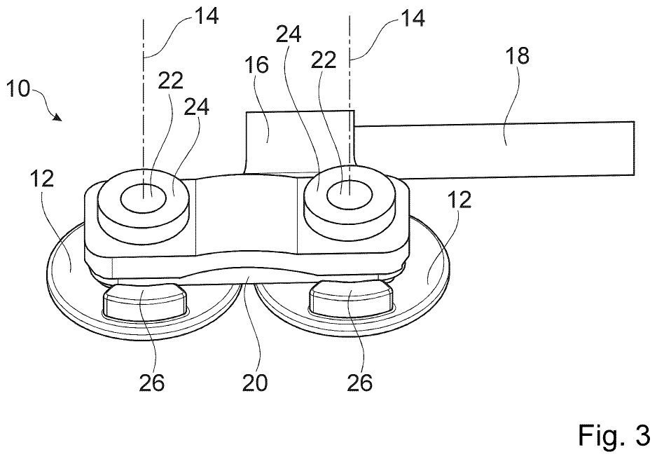

FIG. 3 shows one variant of the first embodiment of a double wastegate valve arrangement in a perspective side view,

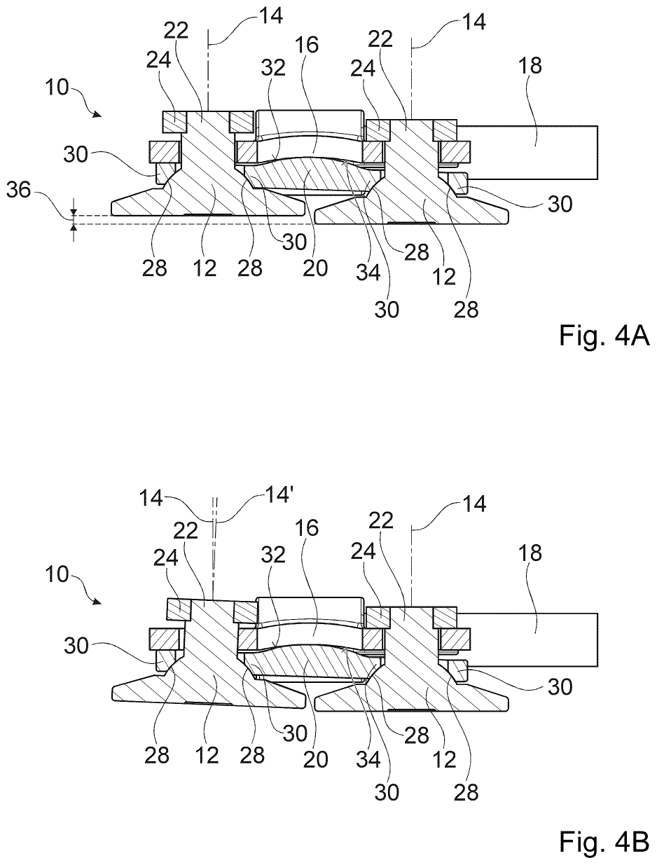

FIG. 4A shows the double wastegate valve arrangement from FIG. 1 in a further cross-sectional view during operation,

FIG. 4B shows the double wastegate valve arrangement from FIG. 1 in a further cross-sectional view during operation,

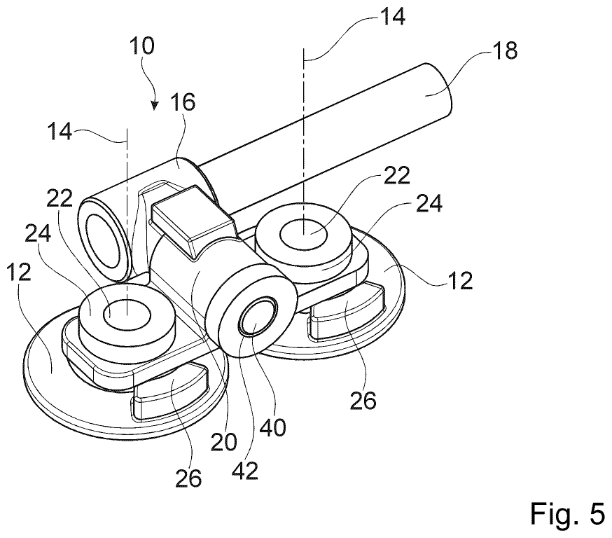

FIG. 5 shows a second embodiment of a double wastegate valve arrangement in a perspective side view,

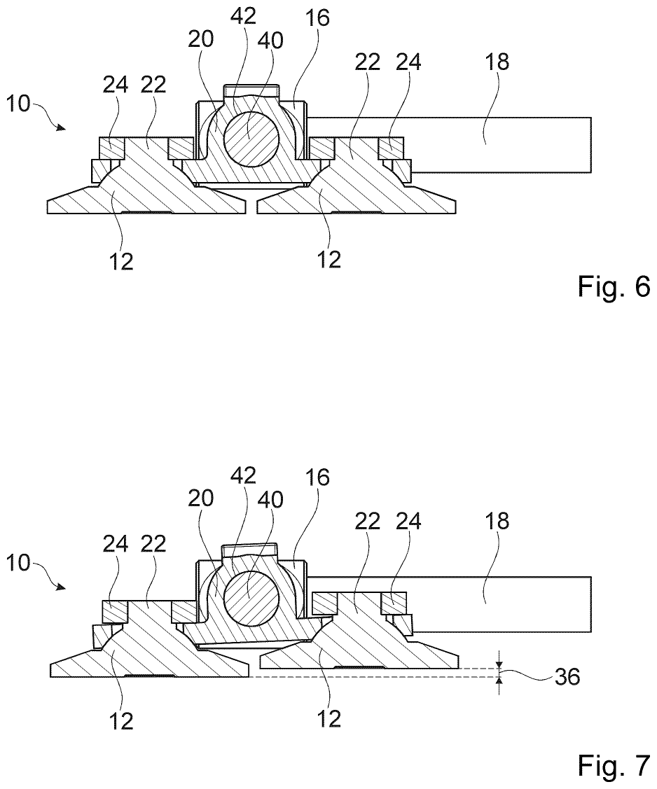

FIG. 6 shows the double wastegate valve arrangement from FIG. 5 in a further cross-sectional view during operation,

FIG. 7 shows the double wastegate valve arrangement from FIG. 5 in a further cross-sectional view during operation,

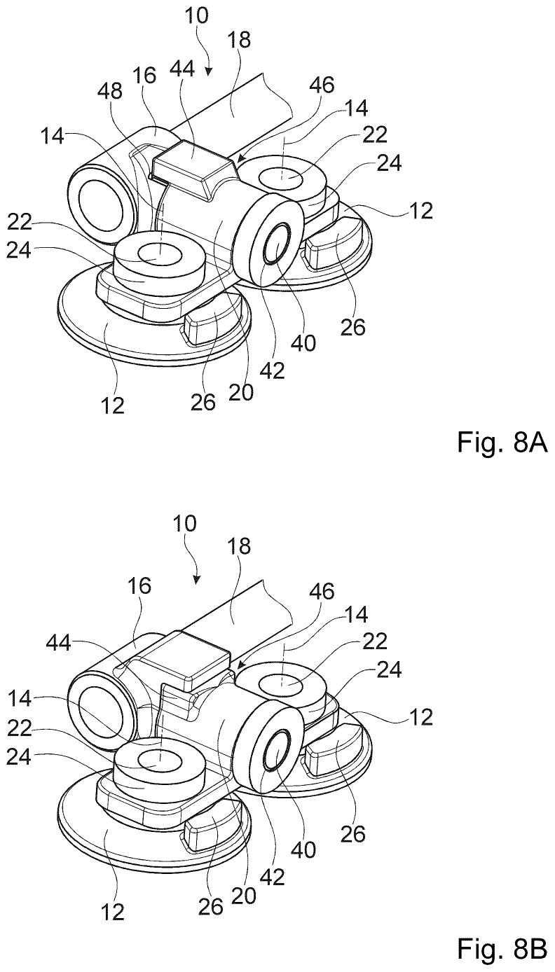

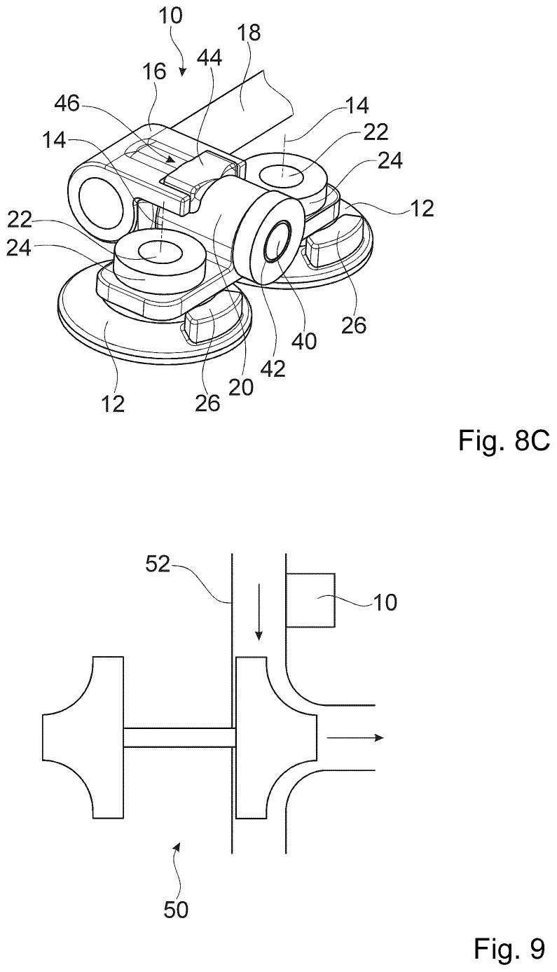

FIG. 8A shows a first variant of the second embodiment of a double wastegate valve arrangement in a perspective side view,

FIG. 8B shows a second variant of the second embodiment of the double wastegate valve arrangement in a perspective side view,

FIG. 8C shows a third variant of the second embodiment of a double wastegate valve arrangement in a perspective side view, and

FIG. 9 shows a turbocharger with the double wastegate valve arrangement according to the invention in a schematic illustration.

FIG. 1 shows a first embodiment of a double wastegate valve arrangement 10 in a perspective side view.

The double wastegate valve arrangement 10 comprises two wastegate valves 12 which are movable along a valve longitudinal axis 14. The valve arm 16 is connected to an actuating shaft 18 which rotates about its longitudinal axis, with the result that the valve arm 16 is moved up or down along the valve longitudinal axis 14. An intermediate plate 20 is arranged loosely between a valve arm 16 and the two wastegate valves 12. Each of the two wastegate valves 12 comprises a valve stem 22 which is passed through openings in the valve arm 16 and in the intermediate plate 20 with play, with the result that it can easily move in a direction perpendicularly with respect to the valve longitudinal axis 14. One end of the valve stem 22 is secured by a washer 24 resting on the valve arm 16. Projecting elements 26 which act in conjunction with the intermediate plate 20 as an anti-rotation blocking means or anti-rotation safeguard are formed on the two wastegate valves 12.

The intermediate plate 20 is pivotable about the valve arm 16 in a direction perpendicularly with respect to the valve longitudinal axis 14. The intermediate plate 20 rests on the rotationally symmetrically designed projecting lower side portions 30 on the rotationally symmetrically designed projecting upper side portions 28 of the two wastegate valves 12.

In FIG. 2 which shows the double wastegate valve arrangement 10 from FIG. 1 in a cross-sectional view, it can be seen that the valve stems 22 are surrounded by rotationally symmetrically designed projecting upper side portions 28. The rotationally symmetrically designed projecting upper side portions 28 can be shaped in different ways around the valve longitudinal axis 14, e.g. conical, as a bevel or spherical. The rotationally symmetrically designed projecting upper side portions 28 of the wastegate valves 12 are in contact with corresponding rotationally symmetrically designed projecting lower side portions 30 which are formed on the intermediate plate 20. Accordingly, the intermediate plate 20 rests on the wastegate valves 12 via rotationally symmetrically designed projecting lower side portions 30 and the rotationally symmetrically designed projecting upper side portions 28. If the upper side portions 28 and the lower side portions 30 are of ball-shaped or spherical design, it is advantageous that a radius of the concave spherical lower side portion 30 on the intermediate plate 20 is greater than or equal to a radius of the convex spherical upper side portion 28 on the two wastegate valves 12.

In addition, it can be seen in FIGS. 1 and 2 that the actuating shaft 18 is connected to the valve arm 16 in a symmetrical position in the middle between the two wastegate valves 12.

As shown in the perspective side view of the double wastegate valve arrangement 10 in FIG. 3, the actuating shaft 18 can also be connected to the valve arm 16 in a position which lies closer to one of the two wastegate valves 12.

One essential feature of the invention is the possibility to compensate for deviations between the two wastegate valves 12 and to ensure a perfect seal of the two valves 12. This is achieved in that the intermediate plate 20, which is not rigidly connected to the valve arm 16 but rather is pivotable, is provided between the valve arm 16 and the two wastegate valves 12. The intermediate plate 20 is pivotable about the valve arm 16 in a direction perpendicularly with respect to the valve longitudinal axis 14. In order to make the intermediate plate 20 pivotable, a plurality of embodiments are possible. In the embodiment shown in FIGS. 1 to 3, corresponding curved regions 32, 34 are formed on the intermediate plate 20 and the valve arm 16.

A positively curved region 32 is formed on the intermediate plate 20, and a negatively curved region 34 is formed on the valve arm. In one preferred embodiment, the curved regions 32, 24 are cylindrically shaped, and a radius of the cylindrical region 32 on the intermediate plate 20 is smaller than or equal to a radius of the cylindrical region 34 of the valve arm 16. Accordingly, an additional force is applied to the wastegate valve 12, which is not yet in contact with its valve seat on the turbine housing, since the intermediate plate 20 is rotating in the direction of this valve, while the other wastegate valve 12 is already in contact with its valve seat.

Thus, horizontal offsets 36 of the two wastegate valves 12 can be compensated for, as can be seen in FIG. 4A which shows the double wastegate valve arrangement 10 from FIG. 1 in a cross-sectional view during operation.

In addition, deviations in the valve longitudinal axis 14 can also be compensated for, as indicated by the inclined valve longitudinal axis 14′in FIG. 4B which shows the double wastegate valve arrangement 10 from FIG. 1 in a cross-sectional view during operation.

Furthermore, Belleville washers can be incorporated on the double wastegate valve arrangement 10 for minimizing noise, which creates constant contact of the components arranged with play with respect to each other. For example, a Belleville washer could be installed underneath the washer 24 between the washer 24 and the valve arm 16.

FIG. 5 shows a further embodiment of the double wastegate valve arrangement 10 in a perspective side view. The same embodiment is shown in FIG. 6 in a lateral cross-sectional view.

The double wastegate valve arrangement 10 comprises two wastegate valves 12 which are movable along the valve longitudinal axis 14. The valve arm 16 is connected to the actuating shaft 18 which rotates about its longitudinal axis, with the result that the valve arm 16 is moved upwards or downwards along the valve longitudinal axis 14. The intermediate plate 20 is arranged loosely between the valve arm 16 and the two wastegate valves 12. Each of the two wastegate valves 12 comprises the valve stem 22 which is passed through openings in the intermediate plate 20 with play, with the result that it can easily move in a direction perpendicularly with respect to the valve longitudinal axis 14. One end of the valve stem 22 is fastened to the intermediate plate 20 by the washer 24. Projecting elements 26 which act in conjunction with the intermediate plate 20 as an anti-rotation safeguard are formed on the two wastegate valves 12.

Similarly to the preceding embodiment of FIG. 1, the double wastegate valve arrangement 10 comprises valve stems 22 which are surrounded by rotationally symmetrically designed projecting upper side portions 28. The rotationally symmetrically designed projecting upper side portions 28 can in turn be shaped in different ways around the valve longitudinal axis 14, e.g. conical, as a bevel or spherical. The rotationally symmetrically designed projecting upper side portions 28 of the wastegate valves 12 are in contact with corresponding rotationally symmetrically designed projecting lower side portions 30 which are formed on the intermediate plate 20. Accordingly, the intermediate plate 20 rests on the wastegate valves 12 via rotationally symmetrically designed projecting lower side portions 30 and the rotationally symmetrically designed projecting upper side portions 28. If the upper side portions 28 and the lower side portions 30 are of ball-shaped or spherical design, it is advantageous that a radius of the concave spherical lower side portion 30 on the intermediate plate 20 is greater than or equal to a radius of the convex spherical upper side portion 28 on the two wastegate valves 12.

In this embodiment, the valve arm 16 contains a pin 40 which engages into a hole 42 in the intermediate plate 20 and creates a rotational connection. Accordingly, the intermediate plate 20 is pivotable about the valve arm 16 in a direction perpendicularly with respect to the valve longitudinal axis 14. As already described in the preceding embodiment, an additional force is also applied to the wastegate valve 12, which is not yet in contact with its valve seat on the turbine housing, since the intermediate plate 20 is rotating in the direction of this valve, while the other wastegate valve 12 is already in contact with its valve seat.

Thus, horizontal offsets 36 of the two wastegate valves 12 can be compensated for, as can be seen in FIG. 7 which shows the double wastegate valve arrangement 10 of FIG. 5 in a cross-sectional view during operation. In addition, an inclination of the valve longitudinal axis 14 can also be compensated for.

The pivoting connection formed by the pin 40 and the hole 42 is limited by a stop element 46. Different embodiments are possible for the stop element 46.

Examples of solutions are shown in FIGS. 8A to 8C which show variants of the stop element 46 of the double wastegate valve arrangement 10 in a perspective side view.

In FIG. 8A, the stop element 46, which forms the anti-rotation safeguard, is defined by a pocket 48 in the valve arm 16 and a matching projecting projection 44 on the intermediate plate 20, which projection fits into the pocket 48. The inclination between the valve arm 16 and the intermediate plate 20 is limited by a flat surface contact between the projection 44 and the pocket 48.

In FIG. 8B, the stop element 46, which forms the anti-rotation safeguard, is defined by a projecting projection 44 on the intermediate plate 20 and a corresponding flat surface on the upper side of the plate, which is located on the valve arm 16. Similarly to the previous version, the inclination is limited by the contact with the flat surface.

In FIG. 8C, the stop element 46, which forms the anti-rotation safeguard, is formed by two projecting projections 44 on the valve arm 16 and matching flat surfaces on the sides of the intermediate plate 20.

As shown in FIG. 9, the above-described double wastegate valve arrangement 10 can be used with a turbocharger 50 which has a twin volute or dual volute 52. The turbocharger 50 can be used in an internal combustion engine operated with diesel, hydrogen, methane or compressed natural gas.

The concept according to the invention can be used in all applications with a high wastegate-bypass ratio and high durability requirements. The invention leads to reduced exhaust-gas leakage through the wastegate valve in turbine housings with two wastegate valves. The invention reduces the total loading of the wastegate system compared to a single-valve solution with the same wastegate port area.

The features mentioned above and in the claims and shown in the figures can be advantageously realised both individually and in different combinations. The invention is not limited to the embodiments described by way of example, but rather can be modified in various ways within the scope of the capabilities of a person skilled in the art.

### LIST OF REFERENCE SIGNS

10 Double wastegate valve arrangement
12 Wastegate valve
14 Valve longitudinal axis
14′ Valve longitudinal axis
16 Valve arm
18 Actuating shaft
20 Intermediate plate
22 Valve shaft
24 Washer
26 Projecting elements
28 Upper part of the side
30 Bottom part of the side
32 Positively curved region
34 Negatively curved region
36 Offset
40 Pin
42 Hole
44 Boss
46 Stopping element
48 Pocket
50 Turbocharger
52 Volute

1. A double wastegate valve arrangement (10), comprising:
two wastegate valves (12) which are movable along a valve longitudinal axis (14), wherein each of the two wastegate valves (12) has a rotationally symmetrically designed projecting upper side portion (28) configured around the valve longitudinal axis (14),
a valve arm (16) which is connected to an actuating shaft (18), and
an intermediate plate (20) which is arranged loosely between the valve arm (16) and the wastegate valves (12), wherein the intermediate plate (20) is pivotable about the valve arm (16) in a direction perpendicularly with respect to the valve longitudinal axis (14), and is supported via rotationally symmetrical projecting lower side portions (30) of the intermediate plate (20) on the rotationally symmetrical projecting upper side portions (28) of the two wastegate valves (12).

2. The double wastegate valve arrangement (10) according to claim 1, wherein the rotationally symmetrically designed projecting lower side portions (30) of the intermediate plate (20) and the rotationally symmetrically designed projecting upper side portions (28) of the wastegate valves (12) are conical or chamfered.

3. The double wastegate valve arrangement (10) according to claim 1, wherein the rotationally symmetrical projecting lower side portions (30) of the intermediate plate (20) and the rotationally symmetrical projecting upper side portions (28) of the wastegate valves (12) are spherical.

4. The double wastegate valve arrangement (10) according to claim 3, wherein a radius of the concave lower side portion (30) on the intermediate plate (20) is greater than or equal to a radius of the convex upper side portion (28) on the two wastegate valves (12).

5. The double wastegate valve arrangement (10) according to claim 1 wherein the actuating shaft (18) is connected to the valve arm (16) in a symmetrical position in the middle between the two wastegate valves (12).

6. The double wastegate valve arrangement (10) according to claim 1 wherein the actuating shaft (18) is connected to the valve arm (16) at a position closer to one of the two wastegate valves (12).

7. The double wastegate valve arrangement (10) according to claim 1 wherein projecting elements (26), which act in conjunction with the intermediate plate (20) as an anti-rotation safeguard of the wastegate valves (12), are formed on the two wastegate valves (12).

8. The double wastegate valve arrangement (10) according to claim 1 wherein the intermediate plate (20) pivots about the valve arm (16) through corresponding curved regions (32, 34) which are formed on the intermediate plate (20) and the valve arm (16).

9. The double wastegate valve arrangement (10) according to claim 6, wherein a positively curved region (32) is formed on the intermediate plate (20), and a negatively curved region (34) is formed on the valve arm (16).

10. The double wastegate valve arrangement (10) according to claim 8, wherein the curved regions (32, 34) are of cylindrical design, and a radius of the cylindrical region (32) on the intermediate plate (20) is smaller than or equal to a radius of the cylindrical region (34) of the valve arm (16).

11. The double wastegate valve arrangement (10) according to claim 1, wherein the valve arm (16) has a pin (40) which engages into a hole (42) on the intermediate plate (20) and creates a pivoting connection.

12. The double wastegate valve arrangement (10) according to claim 11, wherein the pivoting connection is limited by a stop element (46).

13. (canceled)

14. A turbocharger (50) with a double wastegate valve arrangement (10) according to claim 1.

15. The turbocharger (50) according to claim 14 in an internal combustion engine operated with diesel, hydrogen, methane or compressed natural gas.
